(19) United States
(12) Patent Application Publication
(10) Pub. No.: US 2026/0366694 A1
(43) Pub. Date: Nov. 19, 2026

(54) Base Component Forming a Lightweight Bracket

(71) Applicant: Valeo Vision, Bobigny (FR)

(72) Inventors: Robert Fraizer, Auburn Hills, MI (US); Scott Adaska, Troy, MI (US)

(21) Appl. No.: 19/206,274

(22) Filed: May 13, 2025

(51) Int. Cl. F21S 43/33; B29C 70/18; B29K 105/00; B29K 105/26; B29L 11/00; B60Q 1/04; F21S 43/31; F21S 43/37

(52) U.S. Cl. CPC F21S 43/33; B29C 70/18; B60Q 1/0466; F21S 43/31; F21S 43/37; B29K 2105/0032; B29K 2105/26; B29L 2011/0083

(57) ABSTRACT

A base component with two or more structures. The two or more structures are monolithically connected together. The two or more structures include two or more compositions that form each of the two or more structures so that the two or more structures are connected together by the two or more compositions to form the base component. The base component is configured to be connected to a vehicle

### FIELD

The present teachings relate to a lightweight vehicle component that when installed provides multiple different vehicle functions including reflecting light around the vehicle.

### BACKGROUND

Vehicles include many different types of lights. Some types of lights included on a vehicle are low beam headlights, high beam headlights, taillights, turn signal lights, fog lights, running lights, or a combination thereof. Each of these lights extend out of an outer surface of a vehicle so that they provide light for the driver or provide notice to surrounding drivers. These light systems generally direct light outward from the vehicle. These lights may include a reflector that spreads the light across a predetermined region. These reflectors may be made by injection molding. The reflectors may be incorporated into other components or be formed with other components.

Thus, there is a need for a base component that is free a base coat, a metallized layer, or both. There is a need for a material that when formed is smooth. There is a need for base component that reflects a sufficient amount of light so that the light may provide light around a vehicle. It would be desirable to have a bulk molded compound that that may be free any coatings. There is a need for a base component that is formed of multiple different compositions that each provide different functions, different structures, or both. It would be desirable to provide a base component that is one monolithic part with different material characteristics interspersed throughout the base component.

### SUMMARY

The present teachings provide: a base component with two or more structures. The two or more structures are monolithically connected together. The two or more structures include two or more compositions that form each of the two or more structures so that the two or more structures are connected together by the two or more compositions to form the base component. The base component is configured to be connected to a vehicle

The present teachings provide: lighting component comprising a base component with two or more structures and two or more compositions. The two or more compositions comprise a bulk molded compound (BMC), a sheet molding component (SMC), or both comprising: one or more thermoset resins; one or more fillers; one or more reinforcements; one or more binders; two or more inhibitors; and a recycled material. A first structure of the two or more structures has a first composition that is different than a second composition of a second structure of the two or more structures. The first structure and the second structure are connected together to form one monolithic structure. The base component is configured to direct light around a vehicle housing the lighting component

The present teachings provide: a process comprising: forming a plurality of first charges and a plurality of second charges. The plurality of first charges comprise a first composition that comprise: a bulk molded compound (BMC), a sheet molding component (SMC), or both. The plurality of second charges comprise a second composition that comprise: the bulk molded compound (BMC), the sheet molding component (SMC), or both. Placing the plurality of first charges within a first structure of a mold. Placing the plurality of second charged within a second structure of the mold. Heating the mold so that the plurality of first charges and the plurality of second charges at least partially intermix and form a base component that is configured to attach to a vehicle and to direct light around the vehicle.

The present teachings provide a base component that is free a base coat, a metallized layer, or both. The present teachings provide a material that when formed is smooth. The present teachings provide a need for base component that reflects a sufficient amount of light so that the light may provide light around a vehicle. The present teachings provide a bulk molded compound that that may be free any coatings. The present teachings provide a base component that is formed of multiple different compositions that each provide different functions, different structures, or both. The present teachings provide a base component that is one monolithic part with different material characteristics interspersed throughout the base component.

### BRIEF DESCRIPTION OF THE DRAWINGS

FIG. 1 is a side view of a vehicle including a light system.

FIG. 2 is an isometric view of a base component.

FIG. 3A is a plan view of mold cavities within a mold that are configured to form the base component.

FIG. 3B is a cross-sectional view of the mold cavity of 3A cut along lines IIIB-IIIB.

FIG. 3C is a plan view of the mold cavities of FIG. 3A including multiple different charges.

FIG. 3D is a cross-sectional view of the mold cavity of FIG. 3C including the charges cut along lines IIID-IIID.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a base component. The base component may incorporate multiple different devices into a single component. The base component may be formed within a mold. The mold may have two or more molds (e.g., an upper mold and a lower mold). The mold may have openings therein that form a shape of the bracket. The openings may receive a charge, resin, material, a polymer, plastic, or a combination thereof. The openings may receive material by injection. The openings may receive solid materials and then the solid materials may flow within the openings. The openings may be interconnected. The openings may be spaced apart. The openings may connect two or more materials together. The openings may connect a first material to a second material. The openings in the mold may form a shape of the base components. The openings may be configured to form the bosses, the ribs, an area around the connection recesses, walls of the bracket, or a combination thereof. The openings may receive materials (e.g., one of the compositions taught herein) so that the materials may form all or a portion of the bracket.

The base component may be made of multiple different compositions. The base component comprises a plurality of different compositions. The base component may include two or more compositions, three or more compositions, or even four or more compositions. The composition may have interfaces where the compositions mix, overlap, connect, or a combination thereof. An interface may be formed between two compositions with the same characteristics, between two compositions with different characteristics, or a combination of both. The interface may be where two different charges mix. The interface may be where two materials flow and intermix. The interface may be where materials from two different gates collide, mix, connect, flow, contact, or a combination thereof. The interface may be a joint. The interface may not be visible. The interface may be free of any lines, weakness, or both. The base component may have a first composition, a second composition, a third composition, a fourth composition, or a combination thereof. The compositions may be any of the compositions discussed herein. The compositions may form one unitary base component.

The base component may combine multiple different components together into a single device. The base component may be one monolithic piece. The base component may be made of one or more materials, two or more materials, or three or more materials. The various materials of the base components may impart different functions, structures, strengths, weights, or a combination to different portions of the base component. The base component may form all or a portion of a grille, a light system, a head light, a bumper, a bumper support, a frame, a sub-assembly, or a combination thereof of a vehicle. The base component may connect to a light system, a part of a light system, or both. The base component may assist in connecting one or more devices such as a light system into a vehicle.

The base component may be a bracket. The bracket may connect to a vehicle. The bracket may receive other components. The bracket may connect to a vehicle and the bracket may receive other components. Thus, the bracket may act as an intermediary between the vehicle and the other components. The bracket may be a front-end module, a rear-end module, or both. The bracket may assist in connecting lights, a turn signal, fog lights, head lights, a bumper, an area for a radiator, or a combination thereof. The bracket may include bosses, ribs, connection recesses, openings, or a combination thereof. The bracket may include connection devices such as bosses that are configured to connect the bracket to a vehicle. The bosses may connect to the vehicle by one or more fasteners, one or more parts of the vehicle, or both. The bosses may be an annular device with a through hole. The bosses may be made of the same material as a portion of the bracket. The bosses may be sufficiently strong to support the bracket and corresponding components to the vehicle. The bosses may have a sufficient amount of material so that the bosses support the bracket within the vehicle or support other components that are connected to the bracket. The bosses are spaced apart along the bracket. The bosses may be located on opposing sides or edges of the bracket. The bracket may include bosses that are symmetrically located on the bracket, asymmetrically located on the bracket, located all on one side, located on opposing sides, or a combination thereof. The bosses may form connection points that assist in connecting the bracket to the vehicle. The bracket may be reinforced near the bosses or at other locations along the bracket. The bracket may be reinforced by one or more ribs.

The ribs may function to prevent twisting or bending of the bracket. The ribs may provide support relative to a boss, a connection recess, a connection point, an opening in the bracket, an area of the bracket that is free of material, or a combination thereof. The ribs may form a criss-cross pattern. Some ribs may extend in a first direction and some ribs may extend in a second direction that crosses the first direction. The ribs may be in straight lines, parallel lines, parallel to an edge of the bracket, perpendicular to an edge of the bracket, perpendicular to sidewalls of the bracket, or a combination thereof. The ribs may extend outward such that the ribs extends away from a vehicle when the bracket is connected to the vehicle. The ribs may be located in corners of the bracket. The bracket may be free of ribs in some locations. The bracket may be free of ribs around all or a portion of a connection recess but bosses proximate to the connection recesses may include ribs.

The connection recesses function to receive all or a portion of a vehicle component and so that the vehicle component is connected to the bracket. The connection recess may be complementary in shape to a vehicle component so that the vehicle component connects to the bracket. The connection recess may have virtually any shape so that a vehicle component connects to the bracket. The connection recess may be round, square, rectangular, pentagonal, octagonal, geometric, non-geometric, asymmetric, symmetric, or a combination thereof. The connection recesses may be a hole, an absence of material, a opening, or a combination thereof. The connection recesses may be sufficiently stable to support components therein and prevent movement of the components. The bracket may include openings, spaces, absences of material, or a combination thereof where all or a portion of a light or light system fits into the bracket so that the light or light system is connectable to bracket. The connection recess may receive one or more portions of a light system so that the light system is connected to the vehicle.

The present teachings relate to a light system. The light system is located within a vehicle, a base component, or both. Preferably, the light system is part of a vehicle such as a car, motorcycle, bus, truck, semi-truck, SUV, XUV, four-wheeler, dirt bike, tractor, combine, heavy equipment, farm equipment, industrial equipment, commercial equipment, or a combination thereof. The light system may be connected to the vehicle via the base component. The light system may project light in a forward direction, rear direction, side direction, vertical direction (e.g., z-axis), from a fore to an aft, an aft to a fore, or a combination thereof. Preferably, the light system projects a light from an external surface of the vehicle to a location in front of the vehicle or at an angle relative to the front or rear of a vehicle.

The light system may direct some light at the ground. The light system may direct some light above the ground. The light system may be integrated into a front end, a rear end, or both of a car. The light system may be an assembly. The light system may be connected to the base component, incorporated into the base component, or both. The light system may be supported by the base component. The light system may be a sealed light system that is integrated into a vehicle. The light system may be a sub-assembly that is included in a larger light system. The light system may be integrated into another light system and may function to be part of the light system. The light system may project light out of the vehicle. The light system may include multiple different lights or light sub-systems that each provide a different function. The light systems may be multiple light systems or light sources stacked one above the other, side by side, within different planes, within a same plane and projecting in different direction, integrated into a single light system, or a combination thereof. The light system may have multiple smaller light systems or light sources. The light systems may include a body and the body may be covered by one or more outer lenses or may be free of an outer lens.

The outer lens may form an outer most surface of the light system. The outer lens may function to protect all or a portion of the light system. The outer lens may be free of covering a lighting component. The outer lens may cover the lights.

The plurality of light systems or lights may be located in one light system or one or more components. The plurality of light systems may be connected via a base component, a bracket, or both. The plurality of light systems may operate independently of one another such that one light system may not affect another light system or portion of the light system. The light system may provide light with two or more colors, three or more colors, four or more colors, or a combination thereof.

The light sources my function to produce light, may direct light towards a portion of the base component such as a reflector, or both. The light source may be a device or a plurality of devices connected to a vehicle that create light and the light extends outward from the light source. The light source may produce a high beam, a low beam, a blending beam, a running light, a daytime light, a turn signal, a brake light, a warning light, a communication, ornamentation, a signal, decoration, or a combination thereof. The light sources may be spread apart and all connected to the base component. The light sources may only be connected to the base component. The light sources may be free of direct connection to the vehicle. The light sources may have different functions. For example, one light source may provide a running light, another light source may be a turn signal, and another light source may provide a high beam or a low beam. The light source may comprise a plurality of lights or may be a single light source within a set of light sources. The plurality of lights may be in one set or group of light sources. The light source may be a single light that projects light. In another example, a light source may direct light in a first direction. The light sources may direct light in a first direction. The base component may direct light from the light sources in a second direction.

The light sources may be any type of lighting device that produces light such as an incandescent bulb, fluorescent light, compact fluorescent lamp, halogen lamp, light emitting diode (LED), high intensity discharge lamps (HID); halogen lights, xenon lights, a laser diode, phosphorous bulb, or a combination thereof. The light sources may be a single lamp or bulb. Preferably, the light sources are part of a set of light sources that include a plurality of lamps, bulbs, diodes, or a combination thereof. The light sources may be part of a set of light sources that includes 2 or more, 3 or more, 4 or more, 5 more, 7 or more, 9 or more, or 11 or more lights that produce light and combine together to form the light extending from the light system. The sets of light sources may include 20 or less, 18 or less, 16 or less, or 14 or less lights that produce light (e.g., each set may include 8 light sources or alternatively all of the sets when combined together may include 8 light sources or 2 light sources). For example, the set of light sources may be the contents of a single printed circuit board that perform a same lighting function and the set of light sources may be 8 lights.

The number of light sources in a part of the light system may dependent upon a size of the region to be illuminated or an amount of light to be provided. Thus, the light source may be one or more lights, two or more lights, or three or more lights. The light source may be static. The light sources may be free of movement. The light source may be fixed. The light sources may be static and may be manually or physically adjusted so that the light sources are directed to a desired location. The light sources may be fixed and the light from the light source may be moved, bent, directed, or a combination thereof by optical elements, textured portions, micro-optics, or reflectors (e.g., a substrate or a portion of a substrate). Each device (e.g., light or LED) of the light source may be turned on and off. The light sources may be illuminated in a sequence. The light source may be located within a light system at a location relative to a substrate, an edge of a substrate, a side of a substrate, or a combination thereof. The light sources may work together as a set of light sources to create light. All of the light sources may be a same color or provide a same color light. For example, all of the lights may be white or non-colored light. All of the light sources may be a single color light source.

The set of light sources may be connected to a base component and may function to fill a light bar, a lens, an outer housing, an outer lens, light blade, a substrate, an edge of a substrate, a side of a substrate, a reflector, a base component, or a combination thereof so that light projected outward to perform some function. The set of light sources may be a single function (e.g., a high beam, a low beam, a blending beam, a running light, a daytime light, a turn signal, a brake light, ornamentation, a display, signaling, or a combination thereof). Each set of light sources may perform a single function. The light sources may extend in a row, in a column, a straight line, or a combination of both. The light from the light sources may be directed outward from a vehicle so that the light is visible external of the vehicle. The light sources may be controlled my one or more controllers.

The controllers function to control the light sources or the lights within a light source individually. The controller may be part of the vehicle, part of the light system, or both. A single controller may control all of the lights. The controller may illuminate (e.g., fire) the lights in a sequence, individually, in a pattern, a predetermined manner, a predetermined sequence, randomly, or a combination thereof. The controller may be programmable, include pre-set programs, or both. The controller may be accessed inside of the vehicle so that the user can change the illumination settings of the light system. The controller may communicate with light sources through one or more printed circuit boards.

The light sources may be located on or connected to one or more printed circuit boards. The printed circuit boards (PCB) may provide power, signals, support, or a combination thereof to one or more light sources. The PCB may be fixed within a light system. Each PCB may be connected to a plurality of light sources. The PCB may be electrically connected, mechanically connected, or both to one or more light sources discussed herein, the base component, or both. The PCBs may aim the light from the light sources towards a portion of a base component. The PCBs may align light sources with base components, reflectors, or both. The PCBs may be connected to a housing, a base component (e.g., a body), or some other component of a light system or a vehicle.

The base component of the light system functions to connect the lights of the system within a vehicle, to a surface of the vehicle, or both. The base component may include or be connected to one or more light sources, two or more light sources, three or more light sources, or a plurality of light sources. The base component may direct light in a predetermined direction, redirect light in a predetermined direction, or both. The base component may reflect light (e.g., include reflectors). The base component may be a reflector. The base component may be connected to a printed circuit board (PCB) or vice versa. The base component may connect to one or more light systems so that the base component indirectly provides light around the vehicle. For example, light may be directed from a light source towards the base component (e.g., a reflector of the base component) and then the base component may reflect the light outward. The body component may assist in aiming the lights within the light system, the vehicle, or both. The base component may be a central portion that all of the components connect. The base component may be directly connected to a printed circuit board, a controller, a micro-processor, or a combination thereof. The base component may be thermally connected to a printed circuit board, a controller, components on the printed circuit board, or a combination thereof. The printed circuit board, the controller, the light sources, or a combination thereof may be connected to the body.

The base component may have multiple different structures, multiple different compositions, or both. Each of the different structures may be made from different compositions. The different structures may have interfaces where the different compositions merge, mix, converge, or both. The different structures may have different structural characteristics, different colors, different reflective properties, different sizes, different shapes, or a combination thereof. Some base components may reflect light. Some base components may conduct heat.

The base component may reflect light, aim light, spread heat, distribute heat, remove heat, or a combination thereof. The base component may include a reflector portion, a heat sink portion, a heat dissipation portion, or a combination thereof. The base component may be a reflector, a part of the housing, a support bracket, a connection bracket, a substrate of a reflector, a part of a reflector previously made of metal, or a combination thereof.

The base component may have a composition that may be made of or include a first, second, third, fourth, or even more compositions of materials. The base component may be made only of a single composition of material and may be free of other materials, components, coatings, layers, or a combination thereof. The base component may be free of one or more coatings. The composition may be sufficiently rigid to support the light system within a vehicle. The base component may be thermally stable. The base component may be sufficiently thermally stable to prevent melting, softening, or both from lights located proximate to the base component or lights being directed onto the base component that are being reflecting (e.g., after the base component is cured or thermally set). The base component may have a thermal stability of about 550° C. or less, about 450° C. or less, about 350° C. or less, about 300° C. or less, or about 250° C. or less. The base component may have a thermal stability of about 35° C. or more, about 75° C. or more, about 125° C. or more, about 175° C. or more, about 200° C. or more, about 225° C. or more, or about 500° C. or more. The composition of the base component may be a monolithic composition. The base component may be comprised of a plurality of different compositions but all of the different compositions may be combined together to form one monolithic part. The composition may be or include one or more components that when combined together form a body. The composition may comprise filler, glass fibers, binders, thermoplastics, resins, release agents, catalysts, pigments, or a combination thereof. The base component may be comprised of two or more structures, three or more structures, or four or more structures. The structures may each be made of different compositions or materials with a different composition. The composition of each structure may vary based upon where the structure (and corresponding composition) is located within the base component. For example, a boss of the base component may have a composition that is stronger than or more rigid than a structure of the base component that reflects light. The compositions of each of the structures of the base component may have overlapping composition components.

The overlap of the compositional components may include components that are the same from composition to composition. For example, two different compositions may include the same resin. The overlap may include different amounts (e.g., concentrations) of overlapping materials of the composition. The composition may include at least one component that is different. For example, one composition may include a pigment and another composition may include a conductive material. As discussed above, the composition may vary from structure to structure within a base component and the composition differences may form an interface with one another. The interface may be a mixing of compositions within the base component. The amount of one component discussed herein may vary from composition to composition by an amount. The amount that each of the discrete components of the composition may vary is about one percent or more, three percent or more, five percent or more, or about seven percent or more. The amount that each of the discrete components of the composition may vary is about 20 percent or less, about 15 percent or less, about 12 percent or less, or about 10 percent or less. For example, an amount of BMC or SMC may vary from structure to structure of a base component (e.g., the compositions may be varied as discussed above). The composition may include one or more of the following: bulk molded compounds (hereinafter BMC), sheet molded compounds (hereinafter SMC), pigments, conductive material, a thermoset resin, thermoplastic resin, inhibitor, fillers, mold release agent, shrinkage additive, catalyst, reinforcement, binder, a coating, or a combination thereof. The amounts of each component of the composition discussed herein may vary as discussed herein.

The composition of the base component may include one or more bulk molded compounds (hereinafter BMC). The composition may be comprised of some BMC. The composition may be composed of about 40 percent or more, about 50 percent or more, about 60 percent or more, about 70 percent or more, about 80 percent or more, about 90 percent or more, about 92 percent or more, or about 95 percent or more BMC of the total weight of the base component (e.g., ±2 percent). The composition may be composed of about 99 percent or less, about 98 or less, 97 percent or less, 95 percent or less, about 93 percent or less, or about 90 percent or less of the total weight of the base component (e.g., ±2 percent). The BMC may include glass fibers, styrene, an initiator, a shrink additive, inhibitors, a filler, a thermoset resin, calcium carbonate (CaCO₃), crushed glass, binder, polyester, recycled material, post-industrial recycled material, post-consumer recycled material, polymethyl methacrylate (PMMA), talcum powder, magnesium silicide (Mg₂Si), thermoset resin, unsaturated resin, release agent, catalyst, filler, reinforcement, thermoplastic resin, pigment, thickening agents, flash reducer, or a combination thereof. The composition of the BMC may vary from individual component to individual component. For example, an amount of recycle material may be increased or decreased (e.g., by an amount of 1 percent, 2 percent, 3 percent, 4 percent, or 5 percent) based upon where a composition is being located within a given structure (e.g., first, second, third, fourth). The BMC may be mixed with a sufficient amount of pigment that the composition is reflective without coatings or other reflective materials being added on an exterior of the base component.

The pigments may function to provide a color to change a color of the body component or a portion of the body component (e.g., one of the structures) while the other portions remain an original color. The portion of the body component including pigment may have a color that is substantially identical to a color of the pigment. The pigment may include reflective characteristics. The pigment may change a color of the body component so that the portion (e.g., structure) of the body component including the pigment reflects light. The pigment may be a natural material. The pigment may be a synthetic material. The pigment may be a single pigment. The pigment may be a combination of pigments. The pigments may be a granular particle. The pigment may be: titanium dioxide, zinc sulfide, barium sulfide, zinc sulfide, lithophone, alumina hydrate, calcium carbonate, blanc fixe, barytes, talc, silica, silicon dioxide, china clay, zinc white, zirconium dioxide, zirconium oxide, alumilite, antimony(III) oxide, magnesium, mica, or a combination thereof. The pigment may be a fluorescent pigment. The pigment may be stimulated by fluorescent light, UV light, or both. The pigments may be stimulated by fluorescent pigments (e.g., glow or enlighten). The pigments may exclude titanium dioxide or be free of titanium dioxide.

The pigment may be present in a sufficient amount to provide reflective characteristics to the structure of the body component that includes the pigment. The pigment may be present in a sufficient amount to adjust a brightness, whiteness, reflectivity, or a combination thereof of the raw composition without the pigment by an amount of about 4% or more, about 5% or more, about 7% or more, or about 10% or more. The pigment may be present in a sufficient amount to adjust a brightness, whiteness, reflectivity, or a combination thereof of the raw composition without the pigment by an amount of about 25% or less, about 20% or less, about 15% or less, or about 12% or less. One or more segments, two or more segments, or three or more segments may include zero pigment and/or may be free of pigment. At least one segment may include pigment. Two or more segments may include pigment. The pigment, when present, may be present in an amount of about: 0.5 percent or more, about 1 percent or more, about 1.5 percent or more, or about 2 percent or more by total weight of the composition. The pigment, when present, may be present in an amount of about: 10 percent or less, about 7 percent or less, about 5 percent or less, about 4 percent or less, about 3 percent or less, or even about 2.5 percent or less by total weight of the composition. The pigment may have a particle size that is sufficiently small so that the particles change a color, brightness, are dispersed throughout a composition, or a combination thereof of the component. The pigments may be sufficiently small so that the pigments visibly change the brightness, color, or both of the components. The pigments may have a size of about 0.01 mm or more, about 0.05 mm or more, about 0.1 mm or more, about 0.25 mm or more, about 0.5 mm or more, about 0.75 mm or more, or about 0.8 mm or more. The pigments may have a size of about 100 mm or less, about 75 mm or less, about 50 mm or less, about 25 mm or less, about 20 mm or less, about 15 mm or less, about 10 mm or less, about 5 mm or less, about 3 mm or less, about 1 mm or less, or about 0.9 mm or less. The pigment may have a brightness of about 75 or more, about 85 or more, about 90 or more, about 95 or more, or even about 98% pr more. The pigment may have a whiteness index of about 50% or more, 60% or more, 70% or more, 80% or more, 85% or more, 90% or more, or about 95% or more (e.g., a percentage of light reflected by the pigment, the body component including the pigment, or both. The pigment may be homogeneously mixed within the body component. The pigment may be located on an exterior of the body component. The pigment may be added in addition to glass.

The glass may be a recycled glass. The glass may be post-industrial, post-consumer, or both. The glass may be recycled in a similar manner as the other recycled materials (e.g., reduced in size, classified, and added to the composition, the BMC, the SMC, or a combination thereof). The glass may assist in reducing roughness of the base component. The glass may assist in reflecting light. The glass may supplement the pigment. The glass may assist in increasing a brightness, a whiteness, or both. The glass may allow light to extend therethrough so that the light contacts the pigment and is reflected. The glass may be added as a filler. The glass may be added into the resin (e.g., a thermoset resin, a thermoplastic resin, or a combination thereof).

The thermoset resin may be or include polyester, an unsaturated polyester, vinyl ester, epoxy, phenolic, or a combination thereof. The thermoset may react when cured to solidify the BMC, SMC, or both. The thermoset resin may be about 3 percent or more, about 5 percent or more, about 7 percent or more, about 10 percent or more, or about 12 percent or more of the total weight of the base component (e.g., around 7 percent by weight). The thermoset may be about 30 percent or less, about 25 percent or less, about 20 percent or less, about 15 percent or less, about 13 percent or less, or about 35 percent or less of the total weight of the base component. The thermoset may be varied (e.g., between about 2 percent and 5 percent) from composition to composition based upon which structure the thermoset resin will be provided. The thermoset resin may be present in a first composition and a second composition that the two compositions may mix together and form an interface. The thermoset resin may be combined with filler, reinforcement, thermoplastic resin, or a combination thereof.

The resin may be one or more and preferably two or more different resins. The resins may be two different polyesters. The resins may be a BMC resin, a SMC resin, a PMMA resin, or a combination thereof. The resins may have different bonding levels, different bonding timing, different bonding strengths, or a combination thereof. The different resins may provide different properties to the base component. For example, one resin may provide more rigid characteristics (e.g., for connecting to a vehicle) and a second resin may be more flexible (e.g., to attach to a light component or to reflect light). The two or more resins may be added with inhibitors.

The inhibitors may be a free radical inhibitor. The inhibitors may delay a reaction of q free-radical catalyst during injection into a mold. The inhibitors may delay reaction for 1 second or 2 seconds after substantially all of the composition is provided to the mold cavity (e.g., 70% or more, 80% or more, 90% or more of the mold is filled). The inhibitors may delay crosslinking. An amount of inhibitor, type of inhibitor, or both may vary depending on the types of reins inside of each composition. The inhibitors may delay crosslinking until a mold is filled (e.g., 70% or more of the mold is filled). The inhibitors may be or include methyl ethyl ketone peroxide (MEKP), hydroquinone, 4,4-dihydroxybiphenyl, catechols, 3-n-alkyl, 3-isopropyl, 3-phenyl, 4-n-alkyl, 4-isopropyl, 3,5dialkyl, 3,6-dialkyl, hdroxylamines, p-phenylenediamines, ninitro-ortho-cresol, di-nitro-sec-butylphenol, 2,6-Di-tert-butyl-p-cresol, 4-methoxyphenol, 4-tert-butylpyrocatechol, tert-butylhydroquinone, 2-tert-butyl-1,4-benzoquinone, copper(II) Dibtyldithiocarbamate, 2,6-Di-tert-butylphenol, 2-[1-(Hydroxy-3,5-di-tert-pentylphenyl)ethyl]-4,6-di-tert-pentylphenyl Acrylate, phenothiazine, 1,1-Diphenyl-2-picrylhydrazyul free radical, 1,4-Benzoquinone, 6-tert-butyl-2,4-xylenol, or a combination thereof.

The inhibitors function to prevent curing the resins before the resins are moved to a desired location. The inhibitors may partially inhibit curing. The inhibitors may completely prevent curing. The inhibitors may prevent curing until the resins achieve a predetermined temperature. The inhibitors may prevent curing of the resins when the resins are at an injection temperature. For example, the resins may be at room temperature when the resins are injected into the mold and the inhibitors may prevent curing at room temperature. The inhibitors may maintain the resins in a viscous form so that the resins may flow. A first inhibitor (e.g., an injection inhibitor) may work at room temperature to prevent the components of the composition from curing while the composition is being mixed, created, or both. The first inhibitor may be a BMC inhibitor. The first inhibitor may prevent premature reactions at room temperature. The first inhibitor may be or include hydroquinone, 4,4-dihydroxybiphenyl, toluhydroquinone, X-butylhydroquinones, or a combination thereof. The first inhibitor may inhibit a reaction while the composition is waiting further processing (e.g., extending shelf-life). The first inhibitor may inhibit a reaction while a mold is being filled. For example, the mold may have an elevated temperature and the first inhibitor may prevent a reaction beginning until substantially all of the mold is filled. The inhibitors may maintain the resins in a fluid form until the composition is moved into the mold.

The inhibitors may prevent curing when the compositions (including the resins) are being added to the mold. The inhibitors may prevent curing so that a charge may be formed. The charge may be a semi-solid material that is malleable such that when the charge is added to a mold the charge may be adapted to mirror a shape of the mold. A first inhibitor may be gassed off when the composition is added to the mold or formed into a sheet. For example, the mold may increase the temperature of the composition and the increase in temperature may cause a first inhibitor to escape from the mold, stop inhibiting, or both. In another example, the resin may thicken when the first inhibitor is removed so that a sheet is formed. A first inhibitor may be allow a resin to partially solidify while the resin still remains malleable. For example, a sheet molding compound may be formed and then the SMC may be shaped into a charge.

A second inhibitor (e.g., a mold inhibitor) may operate at higher temperatures than the injection inhibitor. The second inhibitor may prevent curing until all of the composition is injected into the mold or the different compositions flow and mix together. The second inhibitor may prevent curing until the composition achieves a predetermined temperature that is higher than the injection temperature or higher than the heating temperature of the mold. The second inhibitor may prevent curing until the composition is increased by about 50° C. or more, about 75° C. or more, about 100° C. or more, or about 125° C. or more. The second inhibitor may prevent curing until the composition is increased by about 300° C. or less, about 250° C. or less, about 200° C. or less, or about 150° C. or less. The second inhibitor may prevent curing until a predetermined temperature is achieved. The second inhibitor may inhibit one or more of the resins or two or more of the resins from curing before the resigns flow into contact. The second inhibitor may assist in preventing a reaction from a beginning of filling of a mold, preheating a mold, heating a mold, closing a mold, inserting charges into a mold, or a combination thereof. The second inhibitor may work with the first inhibitor to prevent a reaction until the mold is substantially full. The first inhibitor may be completely removed before the second inhibitor begins to inhibit. The second inhibitor may prevent gelling, a skin forming, a partial cross-linking, full curing, or a combination thereof. The second inhibitor may prevent curing before a mold is full so that a surface of a resultant part has a substantially constant surface roughness (or lack of roughness). The second inhibitor may be or include catechols with 3-n-alkyl, 3-isopropyl, 3-phenyl, 4-n-alkyl, 4-isopropyl; or a combination thereof. The second inhibitor may be added with a third inhibitor. The second inhibitor may assist the composition in flowing around the mold, into other charges in the mold, in mixing with other charges, or a combination thereof. The second inhibitor and the third inhibitor may function to allow the charges, different compositions, same compositions, or a combination thereof to intermix.

The third inhibitor functions to inhibit a different resin than the first inhibitor, the second inhibitor, or both. The third inhibitor may restrict one resin while a second resin begins curing. The third inhibitor may allow one resin to begin to cure before a second resin begins to cure. The third inhibitor may allow two resins to mix or interface before the resins begin to cure. The third inhibitor may prevent two or more resins from curing until a temperature is achieved, a curing mechanism is introduced (e.g., temperature, moisture, UV. Time, curing component). The third inhibitor may assist in further inhibiting a reaction as the composition is inserted into the mold. The third inhibitor may be used with the first inhibitor, the second inhibitor, or both. The third inhibitor may be used instead of the first inhibitor or the second inhibitor. The third inhibitor may be catechols with 3,5dialkyl or 3,6-dialkyl; or both. The resin may include one or more fillers that are located within the resin along with the inhibitors.

The fillers function to enhance thermal conductivity of the BMC, SMC, or both. The filler may have a high surface area that fills voids between thermoset resin, reinforcement, thermoplastic resin, or a combination thereof. The filler may be calcium carbonate, talcum powder, barium sulfate, sodium sulfate, magnesium silicate, mica, kaolin, calcium silicate, or a combination thereof. The filler may be inert. The filler may be a mixture of fillers listed herein. The filler may be one of the fillers listed herein. The filler may be present in an amount of about 15 percent or more, about 25 percent or more, about 35 percent or more, about 45 percent or more, or about 55 percent or more by weight of the total weight of the base component, composition, or both (e.g., a first composition may have more filler than a second composition). The filler may be present in an amount of about 80 percent or less, 75 percent or less, about 70 percent or less, or about 68 percent or less by weight of the total weight of the base component, the composition, or both. The filler may have a medium particle size of about 1 μm or more, about 3 μm or more, about 5 μm or more, or about 8 μm or more. The filler may have a medium particle size of about 20 μm or less, about 15 μm or less, about 12 μm or less, or about 10 μm or less. The filler may have a surface area of about 0.2 m²/g or more, about 0.4 m²/g or more, about 0.6 m²/g or more, or about 0.8 m²/g or more. The filler may have a surface area of about 3.0 m²/g or less, about 2.0 m²/g or less, about 1.8 m²/g or less, about 1.5 m²/g or less, or about 1.2 m²/g or less. The filler may be mixed with a reinforcement material, a mold release, a catalyst, or a combination thereof as part of the composition of the base component.

The mold release agent may function to prevent shrinkage of the composition, the base component, or both. The mold release agents may assist in maintaining a consistent shrinkage between all of the compositions, structures, or both. For example, if a composition of the structures has a tendency to shrink more than another composition of another structure than the mold release agent may assist in evening out the shrinkage of the structures. The mold release agent may prevent the composition, the base component, or both from sticking to a mold. The mold release agent may be or include zinc, calcium, antimony, wax, fatty ester, silicone, metallic soap, graphite, vegetable oil, mineral oil, or a combination thereof. The mold release agent may be present in an amount of about 0.2 percent or more, about 0.4 percent or more, about 0.6 percent or more, or about 0.8 percent or more by weight of the total weight of the composition of the base component. The mold release agent may be present in an amount of about 5 percent or less, about 3 percent or less, about 2 percent or less, or about 1 percent or less by weight of the total weight of the composition of the base component. An amount of mold release agent may vary based upon which structure (e.g., corresponding part of the mold that forms a given structure) the mold release agent is added into. The mold release agent may be zinc antimony or calcium antimony. In addition to a mold release agent the composition may include a shrinkage additive.

The shrinkage additive may prevent the composition from shrinking during molding, curing, cooling, or a combination thereof. The shrinkage additive may assist in generating consistent shrinkage between the different compositions so that the composition are all sized and shaped according to the sizing within the mold. The shrinkage additive may reduce a total shrinkage of the base component to be about 20% or less, 15% or less, about 10% or less, about 5% or less, about 3% or less, or about 1% or less. The shrinkage additive may reduce a total shrinkage of about 0.25% or more, about 0.5% or more, about 0.75% or more, about 1% or more, but less than 5%. The shrinkage additive may be present in an amount of about 0.5% or more, about 1% or more, about 3% or more, about 5 percent or more, about 10 percent or more, about 20 percent or more, about 40 percent or more, about 60 percent or more, or even as much as 80% by weight of the total weight of the base component. An amount of shrinkage agent may effect an amount of shrinkage of a given composition. An amount of shrinkage agent may be varied depending upon an amount of predicted shrinkage of each given composition. Thus, more shrinkage agent may be provided to areas of a mold (e.g., corresponding to a structure) that include a composition that may shrink more than areas of the mold (e.g., corresponding to a second structure) with compositions that shrink less. The shrinkage additive may be made of or include a filler that is free of any shrinkage such that an amount of shrinkage is reduced relative to an all-virgin composition. The shrinkage additive may be or include a PMMA filler, PMMA resin, glass, CaCO3, talcum powder, fiberglass, gravel mineral, recycled thermoset, BMC scrap, PMMA scrap, or a combination thereof. The shrinkage additive may be added to offset an addition of material that increases shrinkage such that two different compositions may be balanced relative to one another. The composition of the base component may include a mold release agent, a shrinkage additive, and a catalyst.

The catalyst functions to start a reaction, drive a reaction, or both. The catalyst may vary depending on the resin being used (e.g., thermoplastic resin or thermoset resin). The catalyst may be or include ketone, cobalt, peroxyester, a methyl ethyl ketone peroxide (MEKP), vinyl ester, or a combination thereof. The catalyst may be present in an amount of about 0.2 percent or more, about 0.4 percent or more, about 0.6 percent or more, or about 0.8 percent or more by weight of the total weight of the composition of the base component. The catalyst may be present in an amount of about 5 percent or less, about 3 percent or less, about 2 percent or less, or about 1 percent or less by weight of the total weight of the composition of the base component. The catalyst may be varied (e.g., by about ±0.1 percent, ±0.2 percent, or about ±0.3 percent) from composition to composition so that each structure cures similarly to generate a base component with substantially uniformly cured structures. Each of the structures (e.g., first structure, second structure, third structure, fourth structure, etc. . . . ) may include different amounts of reinforcement.

The reinforcement may strengthen the thermoset resin, thermoplastic resin, filler, or a combination thereof. The reinforcement may intertwine with the thermoset resin, the thermoplastic resin, or both. The reinforcement may be fibers, strands, chopped fibers, a crushed material, or a combination thereof. The reinforcement may be a synthetic material, a natural material, glass, fiberglass, cellulose, carbon fiber, metal fibers, or a combination thereof. The reinforcement may be fibers, chopped fibers, crushed fibers, chopped glass fibers, crushed glass, or a combination thereof. When the reinforcement is a fiber the fiber may have a length of about 1 mm or more, about 3 mm or more, about 5 mm or more, or about 6 mm or more. The fiber may have a length of about 20 mm or less, about 15 mm or less, about 10 mm or less, about 8 mm or less, or about 7 mm or less. The reinforcement may be present in an amount of about 5 percent or more, about 7 percent or more, about 10 percent or more, about 11 percent or more, about 12 percent or more, or about 15 percent or more by weight of the total weight of the composition of the base component. The reinforcement may be present in an amount of about 30 percent or less, about 25 percent or less, about 20 percent or less, about 18 percent or less, about 16 percent or less, about 14 percent or less, about 13 percent or less by weight of the total weight of the composition of the base component. Some of the compositions may be free of reinforcement. For example, if the composition when formed into a structure functions to support a light system, the composition may be free of any reinforcement. The composition, when functioning as a support structure (e.g., a boss or a rib) may include reinforcement. The reinforcement may be uniformly located within the composition. The reinforcement may be located within the composition randomly, parallel to one another or a portion of a structure, perpendicular to a portion of a structure, or a combination thereof. The reinforcement may be uniformly mixed within the composition. The reinforcement may be mixed with binder before the reinforcement is added into the composition.

The binder may function to connect all of the components of the BMC together. The binder may chemically or mechanically connect all of the components together. The binder may act as a glue. The binder may be a natural material, a synthetic material, ethylene vinyl acetate, styrene-butadiene, polyacrylamide, starch, rubber, polyester, or a combination thereof. The binder may be present in an amount of about 1 percent or more, about 2 percent or more, about 3 percent or more, about 4 percent or more, about 5 percent or more, or about 7 percent or more by weight of the total weight of the composition of the base component. The binder may be present in an amount of about 20 percent or less, about 15 percent or less, about 10 percent or less, or about 8 percent or less by weight of the total weight of the composition of the base component. The amount of binder may be varied (e.g., by about 0.5 percent, 1 percent, or 2 percent from the aforementioned amounts) based on the amounts and components included in the composition. The binder may be a thermoset resin. The binder may be added in addition to the thermoset resin discussed herein. The binder may be the thermoset resin discussed herein. The binder may be mixed with a thermoplastic resin.

The thermoplastic resin may provide some flexibility in the composition of the base component. The thermoplastic resin may reduce a weight of the base component relative to a base component made of metal (e.g., a plastic part may be 3 percent lighter than a magnesium part). The thermoplastic resin may assist in releasing the base composition from a mold. The thermoplastic resin may be present in an amount of about 1 percent or more, about 3 percent or more or about 5 percent or more by weight of the total weight of the composition of the base component. The thermoplastic resin may be present in an amount of about 15 percent or less, about 10 percent or less, about 7 percent or less, or about 6 percent or less by weight of the total weight of the composition of the base component. The thermoplastic resin may be a polycarbonate, acetal copolymer polyoxymethylene, acetal homopolymer polyoxymethylene, acrylic, acrylic-polymethyl methacrylate (PMMA), nylon, polyethylene, polypropylene, polystyrene, polyvinyl chloride (PVC), polytetrafluoroethylene, polyvinyl acetate, saturated polyesters, or a combination thereof. The thermoplastic resin may be a mixture of components herein. The thermoplastic resin may be PMMA. The composition may be a mixture of filler, reinforcement materials, thermal plastic resins, catalyst, release agents, unsaturated resin, or a combination thereof with thermally conductive components. The resin may include virgin material, recycled material, sustainable materials, renewable materials, or a combination thereof.

The recycled material may be a cured thermoset. The recycled material may be BMC and PMMA. The recycled material may be only BMC or only PMMA. The recycled material may be a mixture of the BMC and the PMMA such that the total amount of recycled material is equal to the percentages discussed herein. For example, if the total amount of recycled material is ten percent then the recycled material may be BMC at 2 percent and PMMA at 8 percent, or if the BMC is at 3 percent then the PMMA is at 7 percent. The recycled material may include PMMA in an amount of up to about 6 percent. The recycled material may include BMC in an amount of up to about 5 percent. The recycled material may replace filler material. The recycled material may reduce a specific gravity of the final composition or final product. The recycled material may be added as a filer. The recycled material may have a lower specific gravity than a traditional filler (e.g., calcium, carbonate).

The recycled material may be post-consumer material, post-industrial material, or both. The recycled material may be material that has been fully processed, cured, thermoset, or a combination thereof. The recycled material may be material that has been cured (e.g., is thermoset). The recycled material may be material that is permanently fixed. The recycled material may be resins that have been cured so that irreversible bonds are created inside of a body component. The recycled material may be material from before a coating is applied. The recycled material may be only material with the base component.

The recycled material may be processed before the recycled materials are added into the composition. The recycled material may be processed by cutting, grinding, crushing, milling, ball milling, pulverizing, shredding, granulating, blending, grinding, regrinding, or a combination thereof. The recycled material may be screened, classified, sorted, or a combination thereof. The screening may remove particles above a certain size. The screening may pass particles below a predetermined size into the composition and particles above a predetermined size back for further processing. The particle size provided to the composition my be about 15 μm or more, about 20 μm or more, about 25 μm or more, about 30 μm or more, about 35 μm or more, about 40 μm or more, about 45 μm or more, or about 50 μm or more. The particle size provided to the composition may be about 150 μm or less, about 125 μm or less, about 100 μm or less, about 75 μm or less, or about 50 μm or less. The screened material may be directly provided into the composition. The screened material may be dissolved and added in as a resin or a fluid material. The screened material may be dissolved in a homopolymer. The screened material may be dissolved in styrene. Some of the screened material recycle may be added as a ground up solid and some of the screen material may be dissolved and added as a liquid.

The recycled material may be added in an amount of about 1 percent or more, 5 percent or more, 10 percent or more, or even 20 percent or of a total weight of the base component. The recycled material may be added in an amount of about 50 percent or less, about 40 percent or less, about 30 percent or less, or about 20 percent or less of a total weight of the base component. The recycled material may be present in a sufficient amount that an amount of shrinkage is reduced relative to a base component that is free of recycled material. The recycled material may be present in a sufficient amount so that the base component shrinks by about 20 percent or less, about 15 percent or less, about 10 percent or less, about 5 percent or less, or about 1 percent or less. The recycled material may be added in place of filler, resin, or both. The recycled material may be provided in place of calcium carbonate. The particles of the recycled material may be harder than the particles of filler (e.g., calcium carbonate). The hardness of the recycled materials prevents the recycled materials from being forced out of the space in the mold (e.g., whereas other fillers may be forced out of the space in the mold). The hardness of the recycled material may be sufficiently high so that the recycled materials create a dam and are retained within the mold. The hardness of the recycled material (e.g., ground up BMC or PMMA) may be about 3 Mohs or more, about 4 Mohs or more, about 5 Mohs or more, or about 6 Mohs or more. The hardness of the recycled material may be about 7 Mohs or less, about 6 Mohs or less, or about 5 Mohs or less. The recycled material may flow within a mold when the composition is injected into the mold.

The recycled materials may be mixed into the composition. The recycled material may be mixed into the BMC so that less virgin BMC is used to create a final product, a composition, or both. As the composition is injected into a mold some of the composition may flow towards edges and/or seams in the mold. For example, if a clamshell mold is used, when the mold is closed, a seam may extend around the mold so that a part may be removed when the composition hardens. The recycled material may contact the seam and prevent composition from extending through the seam. The recycled material may create dams within the mold so that voids in the mold are filled and material is prevented from flowing through the voids. The recycled material may prevent flash, prevent material from exiting the mold, extending into the seam, or both. The recycled material may fill internal voids in the composition as the composition extend into the mold so that a smooth outer surface is formed. The recycled material may extend to an exterior of the base component. The recycled material may be located below an outer surface of the base component such that the recycled material does not form any portion of the outer surface. The recycled material may form a portion of the outer surface but the particle size may be sufficiently small that the virgin material and the recycled material are coplanar such that the recycled material does not adversely change surface roughness. The virgin material may extend around the recycled material so that when the composition contacts an interior surface of the mold, the recycled material and the virgin material are smooth, form a smooth exterior, or both. The surface roughness below are from the prior case.

The recycled materials may be combined with a sustainable material, a renewable material, or both. The sustainable materials, recycled materials, and/or renewable materials (hereinafter sustainable materials) may be made of or include plant-based materials. The sustainable materials may be made of or include starches, cellulose, vegetable oils, land-based plants, water based plants, or a combination thereof. The sustainable materials may be made from algae, rice, corn, trees, chitosan, soy, gluten, gelatin, or a combination thereof. The sustainable materials may be broken down and then formed into a polymer or plastic and then incorporated into the composition set forth herein. The sustainable material may replace all or a portion of a petroleum based material. The sustainable material may be added in an amount of about one percent or more, about two percent or more, about five percent or more, or about seven percent or more of the total weight of the composition. The sustainable material may be added in an amount of about 20 percent or less, about 15 percent or less, or about 10 percent or less. The sustainable material may be added such that surface characteristics are substantially identical as to a base component without any sustainable materials.

The base component has a surface roughness. The surface roughness may be sufficiently smooth so that one or more coatings may be applied (e.g., directly) on the base component. The surface roughness may be sufficiently smooth so that a basecoat is not needed to adhere a coating to the base component. The surface roughness may be about 10 nm or more, about 20 nm or more, about 30 nm or more, about 40 nm or more, about 50 nm or more, or about 75 nm or more. The thermally conductive material may be coated. The surface roughness may be about 200 nm or less, about 150 nm or less, about 125 nm or less, about 100 nm or less, about 75 nm or less, or about 50 nm or less (e.g., between about 83 nm and about 96 nm and preferably about 50 nm and 25 nm). Preferably, the surface roughness is about 30 nm or less. The base component may be sufficiently smooth so that the base component reflects light. The base component may reflect light and scatter the light while reflecting the light so that the light is spread by the base component. The base component has a specular reflection. The specular reflection may indicate an amount of light reflected back, an amount of light that is reflected at a same angle, or both. The specular reflection may indicate an amount of light that is reflected directly back at a location where ethe light originated. The specular reflection may indicate an amount of light that are directed at parallel locations. The specular reflection may be about 70% or more, about 73% or more, or about 75% or more. The specular reflection may be about 95% or less, about 90% or less, about 85% or less, about 80% or less, or about 75% or less. The specular reflection may assist the base component in appearing to have a uniform look, look free of hot spots, scatter light, or a combination thereof. The higher the specular reflection the more hot spots may be present. The lower the specular reflection the less bright the light may be. The specular reflection may be sufficiently high to reflect light and sufficiently low to generate a uniform look (e.g., the base component look like a uniform amount of light is generated by the light system including the base component).

The base component may be free of any coatings. The base component may be free of metal, metallized components, or both. The base component may have an outer surface that may form a reflective surface. An outer surface of the base component may be free of any surface coatings. The outer surface may be free of any surface treatments or finishes. However, surface treatments may be applied to the outer surface to reduce roughness of a green base component (e.g., a component directly from a mold). The outer surface may appear to be white or substantially white.

The teachings herein create a base component that includes a lighting component that may be made by one of more steps taught herein. The lighting component may be one structure of a base component. The lighting component may be virtually any part of the lighting system. The lighting component of the base component may be or include a reflector. The process may begin by forming an article of manufacture (e.g., a body). A base material (e.g., composition) may be mixed together. The base material may include sustainable materials. The base components may include a BMC, SMC, or both. The BMC, SMC, or both may include sustainable materials. The composition may be formed into a body. The composition may be formed into a structure of a body (e.g., a portion of the base component). The base component may be comprised of multiple compositions with different material characteristics (e.g., two or more, three or more, or four or more compositions). The composition material may be formed into a body by extrusion, pultruding, molding, compressing molding, melt molding, transfer molding, injection molding, vacuum molding, or a combination thereof. The composition may be injected into a mold, physically placed into a mold, flow into a mold, pulled into a mold, or a combination thereof. The composition may be formed into a charge and the charge may be inserted into a segment or section of the mold. The charge may flow when heated, placed under pressure, placed under negative pressure, or a combination thereof. Charges may flow into contact with one another. One charge may flow into contact with another charge with a different composition so that different structures of the base component may connect together to form one monolithic part. Multiple different charges may connect together to form a base component.

The base component may be free of any post forming steps. Some structures of the base component may include post forming steps and some structures may be free of post forming steps. The base component may be free of post forming steps such as sanding, spraying, smoothing, surface treatment, or a combination thereof. The body may include post forming steps such as sanding, spraying, smoothing, surface treatment, or a combination thereof. The body may be free of flashing removal (e.g., excess material that forms at or near a seam between two mold portions). The body may be moved directly from a forming step to an assembly step. The coating may be skipped or not used. The base components may be free of a base coat.

A process to form the base component may simultaneously form all of the structures so that the structures are interconnected. The process may result in a monolithic part. The monolithic part may have multiple interfaces where multiple different compositions may interconnect, merge, fuse, combine, or a combination thereof.

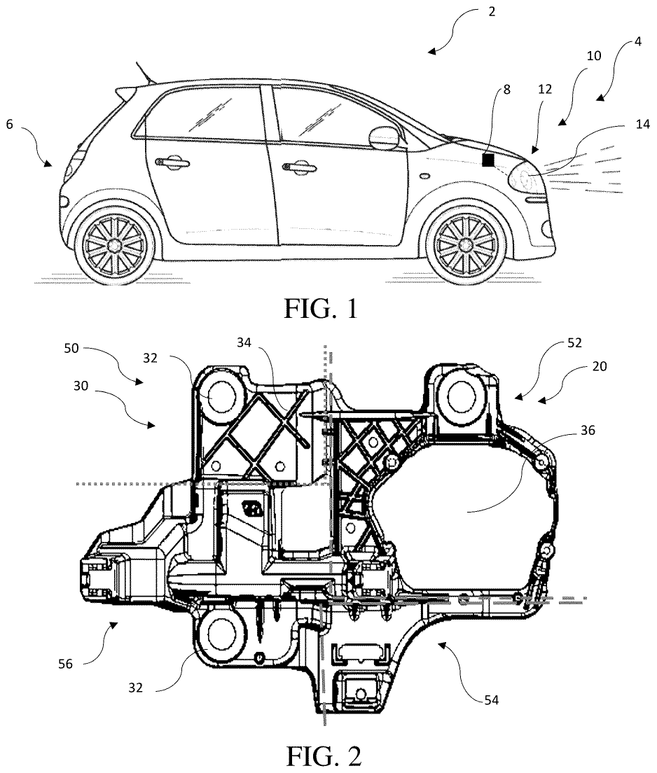

FIG. 1 illustrates a side view of a vehicle 2 including light systems 10. The light systems 10 provide light around the vehicle 2. The light systems 10 are located at a fore 4 end of the vehicle 2 but could be located at an aft 6 of the vehicle 2. The light systems 10 include a body 12 with an outer lens 14. The light systems 10 may be controlled by one or more controllers 8 jointly or individually.

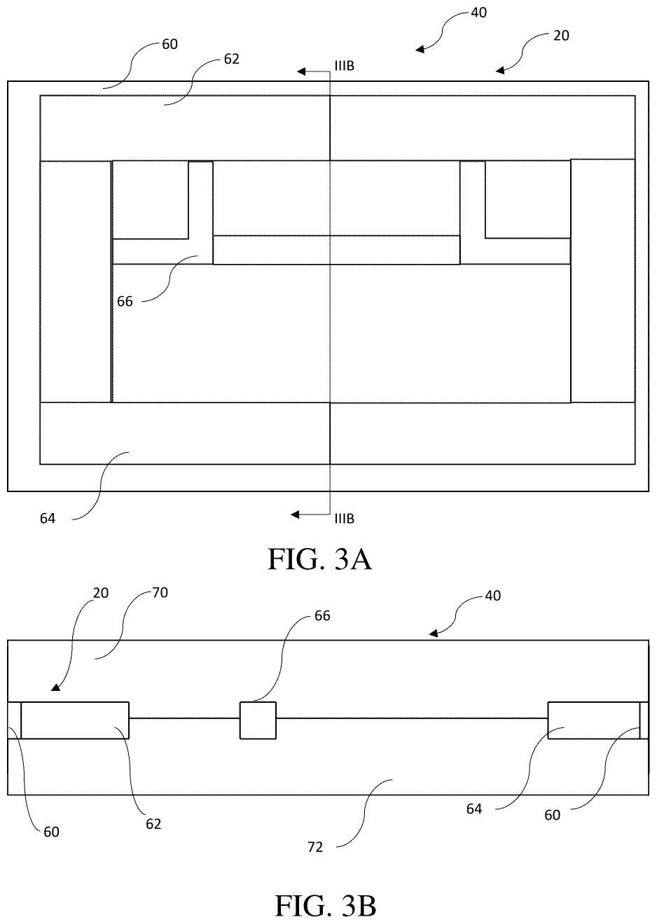

FIG. 2 is an isometric view of a base component 20. The base component 20 as shown is a bracket 30 that includes bosses 32, ribs 34, and connection recesses 36. The base component 20 is made up of multiple different material compositions that each form a different portion of the bracket 30. A first composition 50 may form bosses 32 and ribs 34 of the bracket 30 that provide structural support. The bracket 30 may include a second composition 52 that is monolithically connected to the first composition 50. The second composition 52 may form a connection recess 36 that may receive a light system such as a reflector, light, housing, or a combination thereof. The second composition 52 may have some overlapping components with the first composition 50. The second composition 52 may be monolithically connected to a third composition 54. The third composition 54 may support the second composition 52. The third composition 54 may form a bridge between the second composition 52 and the fourth composition 56. The fourth composition 56 may include bosses 32. The bosses 32 are made of the fourth composition 56. The first composition 50 may connect the base component 20 within a vehicle.

The first composition 50, the second composition 52, the third composition 54, and the fourth composition 56 may all include one or more overlapping components (e.g., BMC), be one monolithic part, form a single part, or a combination thereof. The first composition 50, the second composition 52, the third composition 54, and the fourth composition 56 may each include at least one unique component. The first composition 50, the second composition 52, the third composition 54, and the fourth composition 56 may include different concentrations of components such that the compositions are not identical.

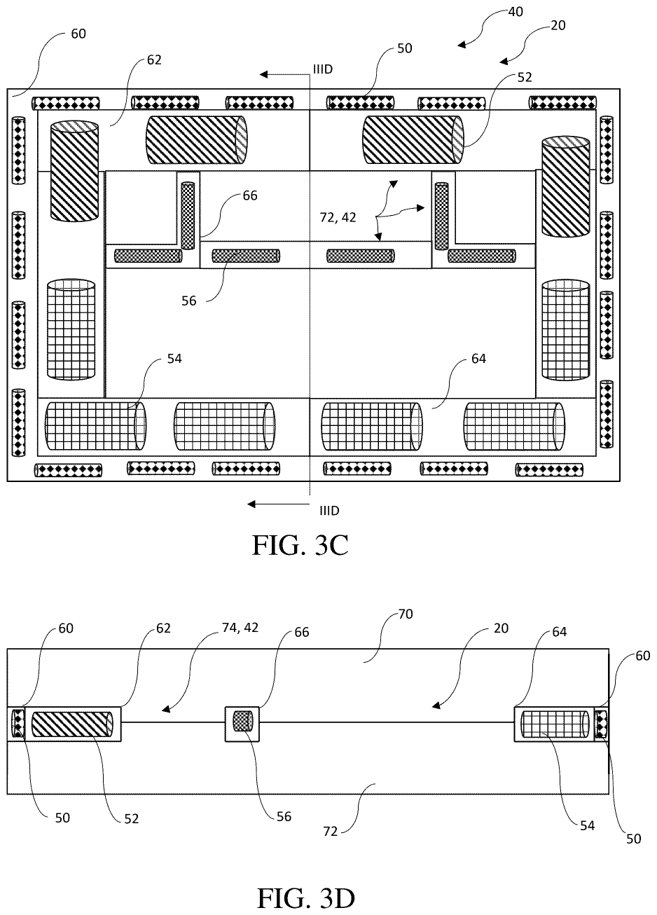

FIG. 3A illustrates mold 40 and a base component 20 including various parts of the base component 20. The base component 20 may form an automotive component such as a front end, or a rear end. The base component 20 includes a first structure 60. The first structure 60 forms a border of the base component 20. The first structure 60 may be connected, have a monolithic interface, or both with one or more second structures 62.

The second structures 62 support the first structure 60, are supported by the first structure 60, or a combination of both. The second structure 62 may extend along one or more sides of the first structure 60, the base component 20, or both. The second structure 62 may form a border or a partial border along the first structure 60. The second structure 62 may extend along or be in contact with one or more sides, two or more side, or three or more sides of the first structure 60, the base component 20, or both. The second structure 62 may be connected to one or more third structures 64.

The one or more third structures 64 may be monolithically connected to a first structure 60, a second structure 62, or both. The third structures 64 may be monolithically connected to the second structures 64 at one or more locations or even two or more locations. The third structures 64 may form one or more shapes. The third structures 64 may be configured to house one or more elements or devices. The third structures 64 may form a portion of one or more devices, a housing of one or more devices, or both. The third structures 64 may mirror the second structures 62. The third structures 64 may be more rigid than the second structures. One or more fourth structure 66 may be monolithically connected to the second structures 62, the third structures 64, or both.

The fourth structures 66 may be a subcomponent of the base component 20 that houses a device, forms a device, forms a portion of the device, or a combination thereof. The fourth structures 66 may form a frame, a housing, or both. The fourth structures 66 may have or form recesses, open spaces, voids, a lack of material, a hole, a housing, or a combination thereof. The fourth structures 66 may form one monolithic part that is connected together. The fourth structures 66 as shown may form two openings and each of the two openings may house a light system.

FIG. 3B is a cross-sectional view of the base component 20 and mold 40 of FIG. 3A along line IIIB-IIIB. The mold 40 comprises a upper mold 70 and a lower mold 72 with an opening 74 therein that forms and holds the base component 20. The opening 74 forms the first structure 60, the second structure 64, the third structure 64, and the fourth structures 66 discussed above so that all of the structures are interconnected and the base component 20 is one monolithic piece.

FIG. 3C illustrates the mold 40 comprising openings 74 in a shape of the base component 20. The openings 74 are filled with charges 42. The charges 42 have a composition with the first composition 50, second composition 52, third composition 54, fourth composition 56, or a combination thereof. As shown, the first structure 60 is filled with the first composition 50, the second structure 62 is filled with the second composition 52, the third structure 64 is filled with the third composition 54, and the fourth structure 66 is filled with the fourth composition 56.

FIG. 3D is a cross-sectional view of the base component 20 of FIG. 3C along line IIID-IIID. A (e.g., a first mold) upper mold 70 and (e.g., a second mold) lower mold 72 form openings 74 that are filled with charges 42. The openings 74 form the first structure 60 is filled with the first composition 50, the second structure 62 is filled with the second composition 52, the third structure 64 is filled with the third composition 54, and the fourth structure 66 is filled with the fourth composition 56.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A base component comprising:
two or more structures that are monolithically connected together and
two or more compositions that form each of the two or more structures so that the two or more structures are connected together by the two or more compositions to form the base component;
wherein the base component is configured to be connected to a vehicle.

2. The base component of claim 1, wherein the two or more compositions comprise:
a third composition that forms a third structure of the two or more structures.

3. The base component of claim 2, wherein the two or more compositions comprise:
a fourth composition that forms a fourth structure of the two or more structures.

4. The base component of claim 1, wherein the two or more compositions include bulk molded compound (BMC), sheet molded compound (SMC), or both.

5. The base component of claim 4, wherein the BMC, the SMC, or both include a recycled material in an amount of about 5 percent or more.

6. The base component of claim 1, wherein the base component is free of metal.

7. The base component of claim 1, wherein a first of the two or more structures is a reflective white composition that form a reflector of the base component to reflect light outward from the vehicle.

8. The base component of claim 7, wherein a second of the two or more structures is a conductive composition that removes heat, distributes heat, or both from the base component.

9. A lighting component comprising:
a base component comprising:
two or more structures; and
two or more compositions comprising:
a bulk molded compound (BMC), a sheet molding component (SMC), or both comprising:
one or more thermoset resins;
one or more fillers;
one or more reinforcements;
one or more binders;
two or more inhibitors; and
a recycled material and
wherein a first structure of the two or more structures has a first composition that is different than a second composition of a second structure of the two or more structures,
wherein the first structure and the second structure are connected together to form one monolithic structure, and
wherein the base component is configured to direct light around a vehicle housing the lighting component.

10. The lighting component of claim 9, wherein the first composition comprises a white pigment and the second structure is free of any white pigment.

11. The lighting component of claim 10, wherein the white pigment is zinc sulfide, barium sulfate, or a combination thereof.

12. The lighting component of claim 11, wherein the white pigment is present in an amount of about 1 percent to about 10 percent of a total weight of the first composition.

13. The lighting component of claim 9 wherein the second composition comprises a conductive material and the first composition is free of the conductive material.

14. The lighting component of claim 9, wherein the first structure of the base component forms a first part of the vehicle and the second structure of the base component forms a second part of the vehicle, wherein the first part and the second part provide different structure to the vehicle.

15. The lighting component of claim 14, wherein the first composition and the second composition have an interface where the first composition and the second composition combine together.

16. A process comprising:
forming a plurality of first charges comprising:
a first composition that comprises:
a bulk molded compound (BMC), a sheet molding component (SMC), or both;
forming a plurality of second charges comprising:
a second composition that comprises:
the bulk molded compound (BMC), the sheet molding component (SMC), or both;
placing the plurality of first charges within a first structure of a mold;
placing the plurality of second charged within a second structure of the mold; and
heating the mold so that the plurality of first charges and the plurality of second charges at least partially intermix and form a base component that is configured to attach to a vehicle and to direct light around the vehicle.

17. The process of claim 16, further comprising:
forming a plurality of third charges comprising:
a third composition that comprises:
the bulk molded compound (BMC), the sheet molding component (SMC), or both.

18. The process of claim 17, further comprising:
forming a plurality of fourth charges comprising:
a fourth composition that comprises:
the bulk molded compound (BMC), the sheet molding component (SMC), or both,
wherein the first composition, the second composition, the third composition, and the fourth composition are different from one another, and
wherein the first composition, the second composition, the third composition, and the fourth composition include the BMC or the SMC.

19. The process of claim 16, wherein the first charge includes only BMC and the second charge includes only SMC.

20. The process of claim 16, wherein the first structure is a location where light is generated and the second structure is a location where the base component connects to the vehicle,
wherein the plurality of first charges include pigment and the plurality of second charges are free of the pigment.
